(19) United States
(12) Patent Application Publication
(10) Pub. No.: US 2012/0140993 A1
(43) Pub. Date: Jun. 7, 2012

(54) SECURE BIOMETRIC AUTHENTICATION FROM AN INSECURE DEVICE

(75) Inventors: Kelsey L. Bruso, Minneapolis, MN (US); Glen E. Newton, Eagan, MN (US)

(73) Assignee: Unisys Corp., Blue Bell, PA (US)

(21) Appl. No.: 12/960,511

(22) Filed: Dec. 5, 2010

(51) Int. Cl. G06K 9/00

(52) U.S. Cl. 382/118; 382/115; 382/124

(57) ABSTRACT

Biometric authentication is enhanced by prompting an individual to perform an action challenge. For example, when an individual provides a facial picture for facial recognition to access secure data the individual may be prompted to provide a second picture of the individual performing an action. In one case, the individual is prompted to provide a second picture with an eye closed or an open mouth. The action challenge improves security by preventing attackers from spoofing an individual's biometric information. The enhanced biometric authentication may be used on mobile devices, such as mobile phones and laptop computers, to provide access to secure data, such as bank account information.

### TECHNICAL FIELD

The instant disclosure relates to authentication devices. More specifically, this disclosure relates to biometric authentication.

### BACKGROUND

Data access on mobile devices is increasing at a rapid pace, which has created problems when authenticating individuals on the mobile device. For example, individuals may have access to their bank account information from their mobile phone or laptop computer but the mobile device may be stolen or misplaced. An unauthorized individual who finds or steals the mobile device should be prevented from accessing secure data through the mobile device. There is no guarantee that the user of the mobile device is an individual authorized to view the information.

One conventional solution is to include user name and password authentication on the mobile device. This authentication technique tests an individual's knowledge and assumes that an individual with the correct user name and password is authorized to access the information. However, the user name and password combinations may be stolen if the media recording the combinations is insecure, or stolen by a hidden camera, or stolen by keystroke recording, or stolen by other social engineering techniques. Additionally, an authorized individual may forget cryptic information such as user name and password combinations.

Another conventional solution uses biometric authentication to test an individual's physical presence. For example, a fingerprint may be stored and the protected information is unavailable unless a user's fingerprint matches the fingerprint of an authorized individual. Although biometric authentication is more difficult to spoof than a username and password combination, biometric authentication is not immune to attacks. For example, a user may mimic an authorized individual's finger with gummy bear jelly placed on the attacker's finger. Additionally, in more extreme cases, an attacker may employ the severed limb exploit by detaching an authorized individual's finger. Conventional biometric authentication may produce false negatives as a result of temperature, humidity, air pressure, aging, pregnancy, injury, or illness. Similarly, when facial recognition is employed to authenticate an individual, the authentication may be spoofed by capturing an image of a photograph.

### SUMMARY

According to one embodiment, a method includes requesting biometric information for an individual. The method also includes receiving biometric information for the individual. The method further includes presenting an action challenge to the individual. The method also includes receiving a response to the action challenge from the individual. The method further includes authenticating the individual based at least on the biometric information and the action challenge response.

According to another embodiment, a computer program product includes a computer-readable medium having code to request biometric information for an individual. The medium also includes code to receive biometric information for the individual. The medium further includes code to present an action challenge to the individual. The medium also includes code to receive a response to the action challenge from the individual. The medium further includes code to authenticate the individual based at least on the biometric information and the action challenge response.

According to yet another embodiment, an apparatus includes a processor and a memory coupled to the processor, in which the processor is configured to request biometric information for an individual. The processor is also configured to receive biometric information for the individual. The processor is further configured to present an action challenge to the individual. The processor is also configured to receive a response to the action challenge from the individual. The processor is further configured to authenticate the individual based at least on the biometric information and the action challenge response.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating an exemplary method for authenticating an individual according to one embodiment of the disclosure.

FIG. 2 is a block diagram illustrating a system for providing secure authentication according to one embodiment of the disclosure.

FIG. 3 is a block diagram illustrating a server according to one embodiment of the disclosure.

### DETAILED DESCRIPTION

Biometric security may be enhanced by prompting the individual requesting access to secure data with an action challenge prompt in addition to collecting and verifying biometric data from the individual. Thus, authentication is a combination of who the individual is and what the individual does.

According to one embodiment, a device may capture an image of an individual's face for facial recognition and prompt the individual to take another picture with open eyes, closed eyes, single closed eye, closed mouth, or open mouth. The challenge action response, a picture of the individual performing the requested action, reduces the likelihood that the facial recognition is being spoofed by a photograph. In another embodiment, the challenge action may be to capture a picture of the individual's head from a different angle. Likewise, this challenge reduces the likelihood of spoofing because the individual must be available to perform the requested action.

According to another embodiment, a device may capture biometric information such as a fingerprint, an iris image, and/or a facial image followed by a motion capture action challenge. For example, during an action challenge the individual may be prompted to record a motion picture of the individual by panning across or around the face from left to right, right to left, top to bottom, or bottom to top. The motion picture action challenge may also include word recognition by prompting the individual to speak a word or phrase while recording the motion picture.

According to yet another embodiment, a device may capture biometric information such as a fingerprint, iris image, facial image and/or video followed by an audio recording action challenge. For example, an individual may be prompted to speak a word or phrase, which is authenticated through voice recognition. In addition, the individual may be prompted to record a video or a video of the spoken phrase for authentication.

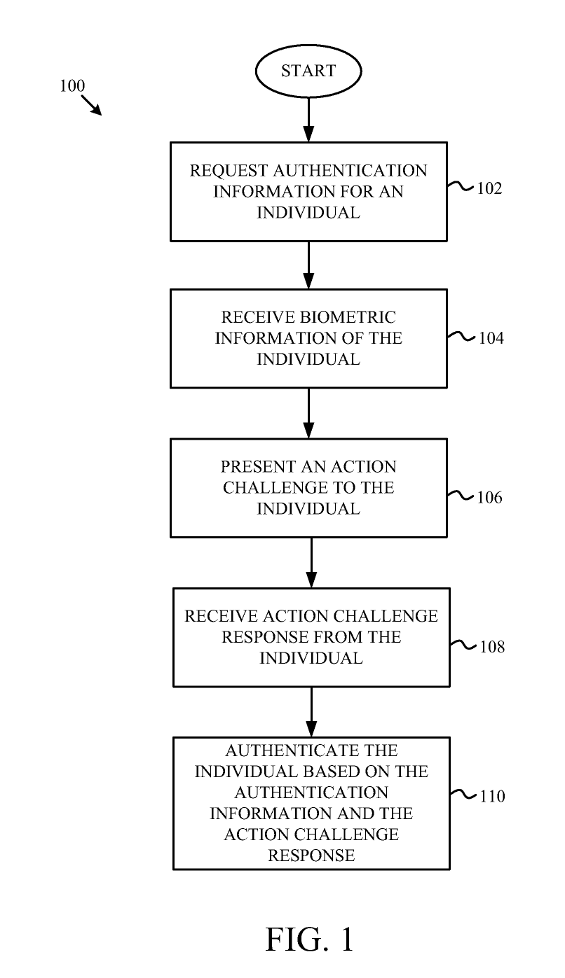

FIG. 1 is a flow chart illustrating an exemplary method for authenticating an individual according to one embodiment of the disclosure. At block 102 biometric information for an individual attempting access to secure data is requested. At block 104 authentication information is received from the individual such as, for example, a fingerprint, an iris image, a picture, and/or a username/password combination.

At block 106 an action challenge is presented to the individual. A random action challenge may be selected from a set of action challenges generally available for authentication or from a set of action challenges specified for the individual identified by the authentication information. According to one embodiment, an action challenge is selected from past history, authentication data, and/or other configuration information. For example, the action challenge may be capturing a picture of the individual from a certain angle, capturing a picture of the individual with a certain expression, capturing a motion picture of the individual in a certain pattern, and/or recording audio of the individual speaking a certain phrase. At block 108 the action challenge response is received from the individual. The response may be received through a still camera, a motion camera, a microphone, and/or a keyboard. According to one embodiment, the action challenge response may be a combination or types of responses or a series of responses of the same type. For example, an individual may be challenged to take a video of themselves saying “holiday” followed by pressing the S key. In another example, an individual may be challenged to take a video of themselves saying “holiday” and a video of themselves by moving the camera from right to left.

At block 110 the individual is authenticated based, in part, on the authentication information and the action challenge response. According to one embodiment, the authentication may also be based on location information available from, for example, a global positioning system (GPS) receiver. When the individual is authenticated the individual is granted access to the secure data. When authentication of the individual fails an error may be reported to the individual, and the individual may be prompted to attempt authentication again.

The authentication may be performed locally on the device accessed by the individual. The authentication may also be performed remotely on a server communicating with the device. For example, if the device is a mobile device such as, for example, a laptop computer or a mobile phone, hardware on the mobile device may record the biometric information and the action challenge response and transmit the information and response to a server. The server processes the information and response to generate an authentication message transmitted to the mobile device. The authentication message instructs the mobile device and/or the server to allow or disallow access to secure data by the individual. The server may also instruct the mobile device of an action challenge for prompting to the individual.

Thus, the authentication process may include steps performed by an authentication server and a client device. According to one embodiment, the steps for authentication on the client device may be integrated into a client plug-in for access on the client device. The plug-in allows applications from different manufacturers executing on the device to perform authentication through the plug-in allowing a single authentication server to allow or disallow access to different types of secure data. The plug-in may be used to perform authentication for access to data such as, for example, bank data.

A bank may provide a mobile application to allow a customer through a mobile phone to access bank account information such as balances and to perform money transfers. The bank application may access a biometric authentication plug-in to contact an authentication service. The bank application may ask the individual to hold the mobile phone one foot in front of the individual's face and capture a picture. The picture may be transmitted to an authentication server, and after an authentication server matches the picture to a registered individual for a bank account, the mobile phone may prompt the individual to complete an action challenge. For example, the individual may be prompted to record a video by moving the mobile phone from a location one foot from the individual's face to a location near the individual's nose. The video may be passed to the authentication server for verification. After the authentication server verifies the individual an authentication message is passed to the mobile phone and the individual is allowed access to bank information. The combination of the biometric information and the action challenge response ensures that the individual accessing the secure data was present at the mobile device and prevents an attacker from gaining access to the secure data with only a photograph of the individual.

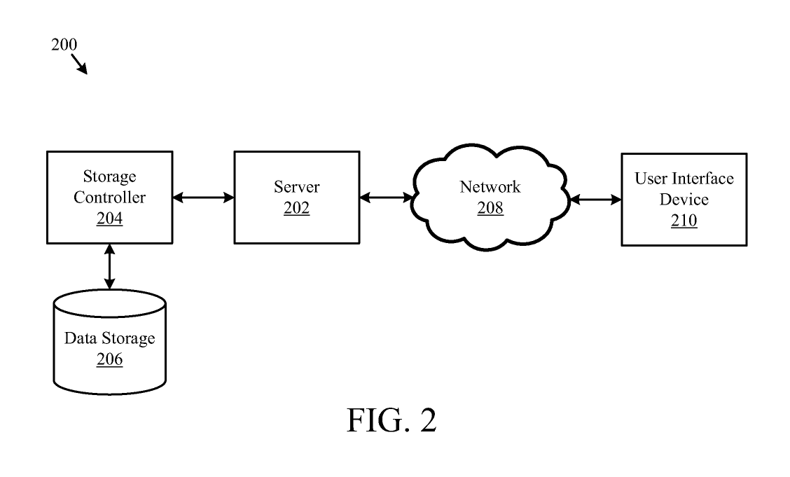

FIG. 2 illustrates one embodiment of a system 200 for providing secure authentication. The system 200 may include a server 202, a data storage device 206, a network 208, and a user interface device 210. In a further embodiment, the system 200 may include a storage controller 204, or storage server configured to manage data communications between the data storage device 206, and the server 202 or other components in communication with the network 208. In an alternative embodiment, the storage controller 204 may be coupled to the network 208.

In one embodiment, the user interface device 210 is referred to broadly and is intended to encompass a suitable processor-based device such as a desktop computer, a laptop computer, a personal digital assistant (PDA) or table computer, a smartphone or other mobile communication device or organizer device having access to the network 208. In a further embodiment, the user interface device 210 may access the Internet or other wide area or local area network to access a web application or web service hosted by the server 202 and provide a user interface for enabling a user to enter or receive information such as biometric information.

The network 208 may facilitate communications of data between the server 202 and the user interface device 210. The data may include biometric information such as fingerprints and iris images and action challenge responses such as video recordings and audio recordings. The network 208 may include any type of communications network including, but not limited to, a direct PC-to-PC connection, a local area network (LAN), a wide area network (WAN), a modem-to-modem connection, the Internet, a cellular network, a combination of the above, or any other communications network now known or later developed within the networking arts which permits two or more computers to communicate, one with another.

In one embodiment, the user interface device 210 accesses the server 202 through an intermediate sever (not shown). For example, in a cloud application the user interface device 210 may access an application server. The application server fulfills requests from the user interface device 210 by accessing a database management system (DBMS). In this embodiment, the user interface device 210 may be a computer executing a Java application making requests to a JBOSS server executing on a Linux server, which fulfills the requests by accessing a relational database management system (RDMS) on a mainframe server. For example, the JBOSS server may receive biometric information from a Java application executing on a mobile device. The JBOSS server may retrieve registered biometric information for authorized users from the mainframe server and compare the registered biometric information with the received biometric information to determine if a match exists.

In one embodiment, the server 202 is configured to store authentication information and action challenges. Additionally, scripts on the server 202 may access data stored in the data storage device 206 via a Storage Area Network (SAN) connection, a LAN, a data bus, or the like. The data storage device 206 may include a hard disk, including hard disks arranged in an Redundant Array of Independent Disks (RAID) array, a tape storage drive comprising a physical or virtual magnetic tape data storage device, an optical storage device, or the like. The data may be arranged in a database and accessible through Structured Query Language (SQL) queries, or other data base query languages or operations.

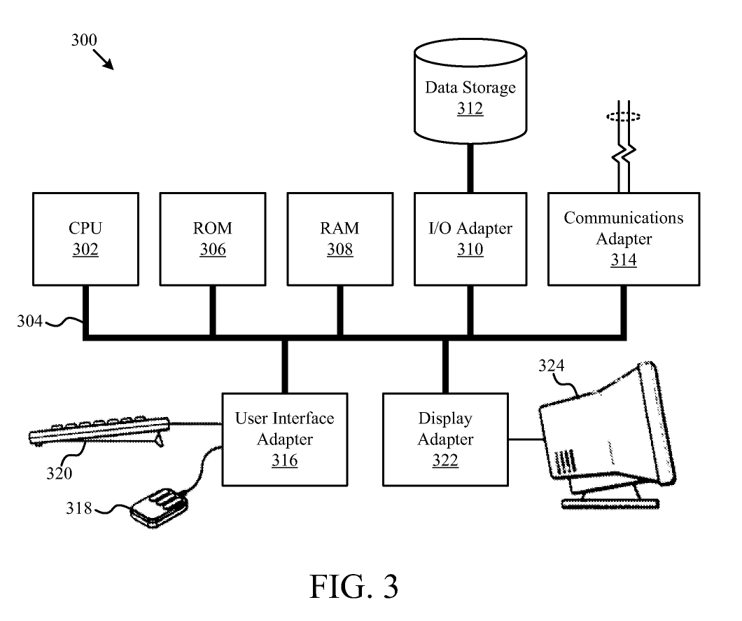

FIG. 3 illustrates a computer system 300 adapted according to certain embodiments of the server 202 and/or the user interface device 210. The central processing unit (“CPU”) 302 is coupled to the system bus 304. The CPU 302 may be a general purpose CPU or microprocessor, graphics processing unit (“GPU”), microcontroller, or the like. The present embodiments are not restricted by the architecture of the CPU 302 so long as the CPU 302, whether directly or indirectly, supports the modules and operations as described herein. The CPU 302 may execute the various logical instructions according to the present embodiments.

The computer system 300 also may include random access memory (RAM) 308, which may be SRAM, DRAM, SDRAM, or the like. The computer system 300 may utilize RAM 308 to store the various data structures used by a software application such as markup language documents. The computer system 300 may also include read only memory (ROM) 306 which may be PROM, EPROM, EEPROM, optical storage, or the like. The ROM may store configuration information for booting the computer system 300. The RAM 308 and the ROM 306 hold user and system data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300. In a further embodiment, the display adapter 322 may display a graphical user interface associated with a software or web-based application. For example, the display adapter 322 may display menus allowing an administrator to input data on the server 202 through the user interface adapter 316.

The I/O adapter 310 may connect one or more storage devices 312, such as one or more of a hard drive, a compact disk (CD) drive, a floppy disk drive, and a tape drive, to the computer system 300. The communications adapter 314 may be adapted to couple the computer system 300 to the network 108, which may be one or more of a LAN, WAN, and/or the Internet. The communications adapter 314 may be adapted to couple the computer system 300 to a storage device 312. The user interface adapter 316 couples user input devices, such as a keyboard 320 and a pointing device 318, to the computer system 300. The display adapter 322 may be driven by the CPU 302 to control the display on the display device 324.

The applications of the present disclosure are not limited to the architecture of computer system 300. Rather the computer system 300 is provided as an example of one type of computing device that may be adapted to perform the functions of a server 202 and/or the user interface device 210. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
requesting authentication information for an individual;
receiving authentication information for the individual;
presenting an action challenge to the individual;
receiving a response to the action challenge from the individual; and
authenticating the individual based at least on the authentication information and the action challenge response.

2. The method of claim 1, in which the authentication information is at least one of a fingerprint, an iris image, a facial image, and a username and password combination.

3. The method of claim 1, in which the action challenge is at least one of a picture challenge, a video challenge, and an audio challenge.

4. The method of claim 1, in which the authentication information is a picture of a face of the individual and the action challenge response is a picture of a different side of a head of the individual.

5. The method of claim 1, in which the step of requesting authentication information and the step of presenting an action challenge are performed by a client application.

6. The method of claim 5, in which the step of authenticating comprises:
transmitting, from the client application, the authentication information and the action challenge response to an authentication server; and
receiving, at the client application, an authentication response from the authentication server.

7. The method of claim 5, in which the client application is a mobile client application.

8. A computer program product, comprising:
a computer-readable medium comprising:
code to request authentication information for an individual;
code to receive authentication information for the individual;
code to present an action challenge to the individual;
code to receive a response to the action challenge from the individual; and
code to authenticate the individual based at least on the authentication information and the action challenge response.

9. The computer program product of claim 8, in which the code to receive authentication information receives at least one of a fingerprint, an iris image, and a facial image.

10. The computer program product of claim 8, in which the code to receive the action challenge response receives at least one of a picture challenge, a video challenge, and an audio challenge.

11. The computer program product of claim 8, in which the code to receive the authentication information receives a picture of a face of the individual and the code to receive the action challenge response receives a picture of a different side of a head of the individual.

12. The computer program product of claim 8, in which the medium further comprises code to select an action challenge based on at least one of past history and available authentication data.

13. The computer program product of claim 12, in which the code to authenticate comprises:
code to transmit the authentication information and the action challenge response to an authentication server; and
code to receive an authentication response from the authentication server.

14. An apparatus, comprising:
at least one processor and a memory coupled to the at least one processor, in which the at least one processor is configured:
to request authentication information for an individual;
to receive authentication information for the individual;
to present an action challenge to the individual;
to receive a response to the action challenge from the individual; and
to authenticate the individual based at least on the authentication information and the action challenge response.

15. The apparatus of claim 14, further comprising:
a fingerprint scanner coupled to the at least one processor; and
a camera coupled to the at least one processor, in which the at least one processor is further configured:
to receive the authentication information from the fingerprint scanner; and
to receive the action challenge response from the camera.

16. The apparatus of claim 14, further comprising a camera, in which the at least one processor is further configured:
to receive the authentication information from the camera; and
to receive the action challenge response from the camera.

17. The apparatus of claim 14, further comprising a microphone, in which the at least one processor is further configured:
to receive the action challenge response information; and
to authenticate the individual based, in part, on the audio challenge response information.

18. The apparatus of claim 16, further comprises a global positioning system (GPS) receiver, in which the at least one processor is further configured:
to receive position information from the GPS receiver; and
to authenticate the individual based, in part, on the position information.

19. The apparatus of claim 16, in which the camera is at least one of a still camera and a video camera.

20. The apparatus of claim 19, in which the apparatus is a mobile device, and the at least one processor is configured:
to receive a selection of an action challenge from a remote authentication server;
to transmit the authentication information and the action challenge response to the remote authentication server; and
to receive an authentication response from the remote authentication server.
